(19) United States
(12) Patent Application Publication
(10) Pub. No.: US 2006/0287870 A1
(43) Pub. Date: Dec. 21, 2006

(54) Method and arrangement for delivering mail

(76) Inventors: Boris Mayer, Bonn (DE); Flavio Alario, Bonn (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/569,925

(22) PCT Filed: Aug. 31, 2004
(86) PCT No.: PCT/EP04/09681

§ 371 Date: Feb. 27, 2006

(30) Foreign Application Priority Data
Sep. 2, 2003 (DE) 103 40 904.1

(51) Int. Cl. G06Q 99/00

(52) U.S. Cl. 705/1

(57) ABSTRACT

A method for delivering mail, wherein the mail is transported to a delivery address and a notification message is deposited thereon if the mail cannot be delivered to an authorized recipient. A charging area of a packet mailbox is allocated to the recipient of the mail by means of an identifier, such as a bar code. The identifier is applied to the notification message together with position information of the packet mailbox and data of the recipient, such that the collector can collect the mail, for example, with the aid of a notification card on the packet mailbox.

The invention relates to a method for delivering a shipment, wherein the shipment is transported to a delivery address at which a notification means is deposited if it is determined that the shipment cannot be handed over to an authorized recipient.

The invention also relates to an arrangement for carrying out the method.

When shipments are delivered to a delivery address of a recipient, it is a known procedure for the deliverer to leave a notification at the delivery address if he was not able to hand over the shipment to an authorized recipient. Such shipments are, for example, parcels or packages that, due to their size, cannot be placed into conventional mailboxes. Moreover, these might also be mail requiring proof of delivery such as registered letters or COD shipments for which a payment must be made upon receipt.

Typically, a notification consists of a notification card indicating the recipient and the post office branch at which the shipment can be picked up by the recipient at a later point in time. In most cases, however, the shipment is only ready to be picked up on the next workday and the period of time during which it can be picked up depends on the opening hours of the particular branch office. This is very disadvantageous for the recipient since the opening hours of the branch office considerably restrict the possibilities of recipients. For example, it is difficult for recipients who hold jobs to go to a branch office during its opening hours since this time period typically coincides with their own working hours.

Moreover, branch offices can be overcrowded at certain times, which means a further loss of time for recipients, something which is not very convenient for them. As a result, they often cannot pick up their shipments at the first possible opportunity, but rather, there can be a considerable delay in time due to various negative factors.

In case a shipment cannot be handed over to an authorized recipient at a delivery address, there is thus a need for methods with which the above-mentioned disadvantages do not occur. Consequently, known methods employ, for example, special compartments at the delivery address to which a deliverer has access. Thus, large shipments that require a correspondingly large compartment can be deposited by the deliverer. However, this solution calls for a great deal of effort on the part of the recipient since all potential recipients of shipments have to install a large compartment at their delivery address. This is structurally difficult to achieve since it requires too much space. Furthermore, no mail requiring proof of delivery and/or COD shipments (cash on delivery) can be deposited in this manner.

Moreover, it is a known procedure to operate systems with electronic compartment systems in such a way that users are registered in the system by providing various data, as a result of which they can use the compartment systems. This registration data includes, for example, name, address and bank account number, or cell phone numbers or e-mail addresses. Cell phone numbers and e-mail addresses are used particularly in order to send messages to users of the system.

Such a compartment system can be a parcel compartment system that has compartments of different sizes for depositing shipments such as parcels. The parcel compartment system is typically connected to a central data management unit, such as a server, in which data about the procedures at various parcel compartment systems is managed.

If a recipient is a registered user of such a system, a shipment can be deposited in a parcel compartment system if the recipient cannot be reached at the delivery address. After the shipment has been deposited, the recipient can be notified, for example, by SMS or e-mail, that a shipment has been deposited for him. Moreover, a shipment-specific identification code can be transmitted together with the message, thus authorizing the recipient to pick up the shipment. Furthermore, for identification purposes, at the time of the registration, a person-specific identification means can be issued with which the recipient can identify himself at the parcel compartment system. This can be, for example, a card or another code.

Consequently, by virtue of the registration data about the recipient as a user of the system, notifications with shipment-specific codes can be transmitted to him and he can be identified when he picks up a shipment at the parcel compartment system. This is not the case with unregistered recipients, so that such methods cannot be used. However, since it is difficult to achieve a registration of all potential recipients and since it might be the case that not all recipients have the capability to receive notifications via SMS or e-mail, there is still a need for a new method for delivering shipments. Since the use of parcel compartment systems is restricted to registered users, the capacity of the parcel compartment systems employed is not always fully utilized.

The objective of the invention is to provide a method for delivering a shipment with which a recipient can flexibly and conveniently pick up a shipment at a storage location in case the shipment could not be handed over to him at a delivery address. In this context, especially the above-mentioned drawbacks are to be avoided.

The objective of the invention is also to provide an arrangement for carrying out the method. With this arrangement, in particular, the capacity utilization of known parcel compartment systems is to be increased.

This objective is achieved by a method according to claim 1. The objective is also achieved by an arrangement for carrying out the method according to claim 23. Additional advantageous and practical embodiments can be gleaned from the subordinate claims.

According to the invention, a method for delivering a shipment—wherein the shipment is transported to a delivery address at which a notification means is deposited if it is determined that the shipment cannot be handed over to an authorized recipient—is carried out in such a way that a storage place in a parcel compartment system is associated with the recipient of a shipment via a shared identification means. Here, the notification means is provided at least with information for identifying the parcel compartment system, with data about the recipient and with the identification means.

If a deliverer cannot hand over a shipment to an authorized recipient, he associates a storage place in a parcel compartment system with the recipient who was not, available. Since the recipient can be associated with his shipment, it is also the case that an association is made indirectly between the shipment and a storage place. This storage place is a free compartment in the parcel compartment system in question. Here, a firm reservation of a compartment can be made so that the deliverer has to deposit the shipment at a parcel compartment system into the compartment associated with the recipient. In another preferred embodiment of the invention, no firm reservation is made, but rather a potentially free compartment is merely associated with the identification means. In this case, the final association with a specific compartment is only made at the parcel compartment system.

The identification means can be, for example, a code or RFID (radio frequency identification). Here, the first association of the code with a storage place can be made before or after the determination that a shipment could not be handed over. If this is done before the determination, then, in an especially preferred embodiment of the invention, notification cards are generated for each available free compartment in the delivery district of the deliverer before the deliverer begins his delivery route. Information for identifying the parcel compartment system in question and an issued code are applied onto these notification cards. The information for identifying a parcel compartment system is preferably location information. Thus, for each potentially available compartment on the deliverer's route, he takes along a notification card onto which a code has been applied. The subsequent association of the compartment with the recipient is preferably carried out by the deliverer, who applies data about the recipient onto the notification card if he determines that he cannot hand over the shipment.

If the association is made after the determination that the shipment cannot be handed over, then, in another especially preferred embodiment of the invention, current information about free compartments in the delivery district of the deliverer is transmitted to him at the delivery address. The transmission can be carried out, for example, via a portable device such as a handheld device that is connected to a central data management unit that stores and manages information about current capacities. Hence, a notification card is only provided on site with the location information of a parcel compartment system. The identification means can already be present on a prepared card or else it can likewise be generated and applied only at the point in time of the delivery. In this embodiment, the association with a recipient is also made by the deliverer, who applies the applicable recipient data onto the card.

The deliverer leaves the generated notification means at the delivery address and the shipment is transported to the parcel compartment system in which a compartment has been associated with the recipient. It has proven to be advantageous for the association with a free compartment not to entail an association with a specific compartment of the parcel compartment system but rather to be only an association with one of several possible compartments. This, however, can include, for example, an association with a group of compartments of the same size.

When the deliverer deposits the shipment, at least the identification means associated with the recipient of the shipment is recorded. The identification means is stored so as to match the compartment in which the shipment has been deposited. For purposes of a later comparison between the person picking up the shipment and the actual recipient, it is advantageous to record additional recipient data. Moreover, if the item is a COD shipment, then the applicable monetary sum and sender name are also recorded. The payment of this monetary sum is advantageously a prerequisite for the release of the shipment when a person picks up the shipment.

When a person picks up the shipment from the parcel compartment system, at least the identification means that is associated with the recipient and that is present on the notification means is recorded. If a barcode has to be scanned in for this purpose, then the person picking up the shipment has to bring the card along to the parcel compartment system. If the person picking up the shipment merely has to enter a numerical code or a letter code, it is sufficient if that person can enter it from memory.

After the identification means associated with the recipient has been recorded, it is compared to the identification means stored for the compartments of the parcel compartment system. If the result of the comparison shows that the identification means associated with the recipient matches one of the stored identification means, then the shipment is released.

If the item is a COD shipment, a prerequisite for the release of the shipment can be that the person picking it up first has to make a payment. The monetary sum can be paid, for example, via a card function with an EC card or else in cash.

Another prerequisite for the release of a shipment can be that the person picking it up must be the recipient. For this purpose, it is advantageous to record data about the person picking up the shipment. If this data matches the recipient data entered by the deliverer, then the shipment can be released. If the data about the recipient and the data about the person picking up the shipment do not match, then preferably a function is activated by means of which the person picking up the shipment can indicate that he is the substitute recipient, which can be a prerequisite for the release of the shipment.

Since the data about the recipient and the data about the person picking up the shipment can differ, for example, due to different spellings or due to typing errors so that a 100% positive match is not possible, then an especially preferred embodiment of the invention provides that the data only has to match to a certain degree. The match can also be limited to a portion of the data so that, for example, only the recorded last names are compared.

Since proof of delivery is required for various types of shipments, as a result of which the pick-up has to be confirmed and the person picking up the shipment has to be identifiable, the input of data by the person picking up the shipment entails a high risk of forgery and fraud. Therefore, the signature of the person picking up the shipment can be recorded in order to confirm the pick-up. This can be done by placing a signature, for example, via a touch screen or by reading in the signature from means that has already been provided with the signature. These means include, for instance, the notification card and/or a personal identity card. The data about the person picking up the shipment can likewise be recorded by means provided with this data.

The arrangement according to the invention for carrying out a method for delivering a shipment comprises at least one central data management unit and an electronic parcel compartment system that each have means for exchanging data, whereby the parcel compartment system has at least means for recording, storing and comparing identification means. The arrangement also comprises at least means for generating an identification means, whereby the identification means serves to associate a recipient of a shipment with a storage place in a parcel compartment system. The arrangement also comprises means for generating information about storage places in a parcel compartment system, whereby the information serves to associate a recipient of a shipment with a storage place. Means for generating a notification means are likewise provided, whereby the notification means can be provided with data for identifying a parcel compartment system, with data about the recipient and with the identification means.

The method according to the invention and the arrangement for carrying out the method entail various advantages. The recipient can pick up his shipment, for example, as soon as it has been placed into a parcel compartment system by the deliverer. In the most favorable scenario, this can be immediately after receipt of the notification card. Here, the recipient is not bound to any of the opening hours of a branch office so that he can select any time to pick up the shipment. This gives the recipient a high degree of flexibility and furthermore, the branch offices of a postal service provider are alleviated of the burden of having to hand out packages.

Furthermore, the pick-up does not require any registration for which the user has to provide personal data. Moreover, for a postal service provider, the method constitutes a simple way with which to allow unregistered users to benefit from the use of parcel compartment systems without there being a need for extensive data acquisition and data administration measures. In this manner, the capacity utilization of parcel compartment systems can be increased.

Additional advantages, special features and advantageous embodiments of the invention can be gleaned from the subordinate claims and from the presentation below of preferred embodiments making reference to the figures.

The figures show the following:

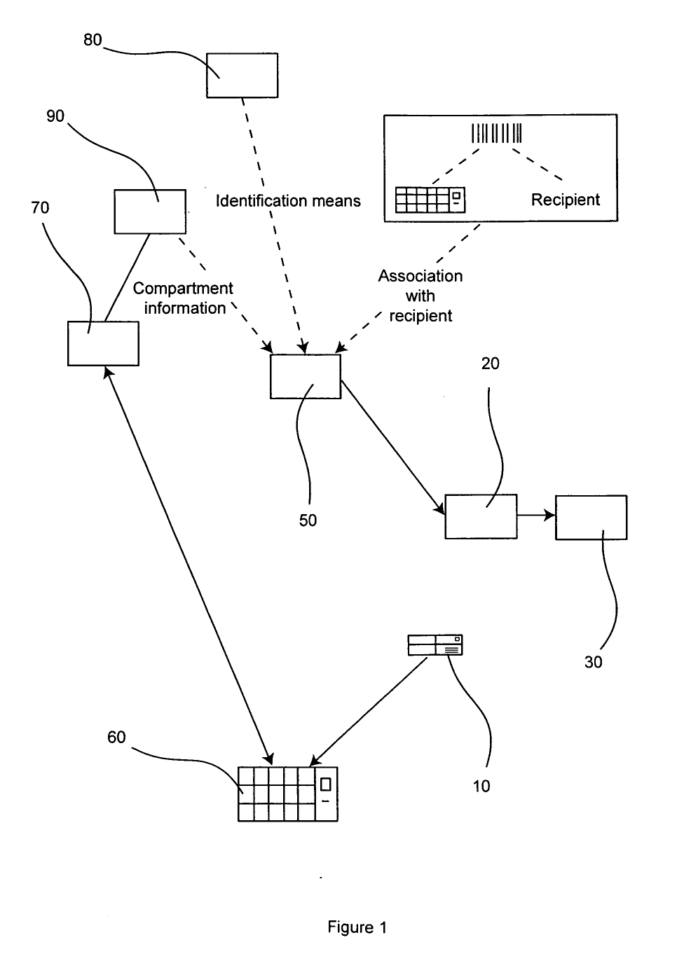

FIG. 1 a schematic depiction of the sequences of the method according to the invention; and

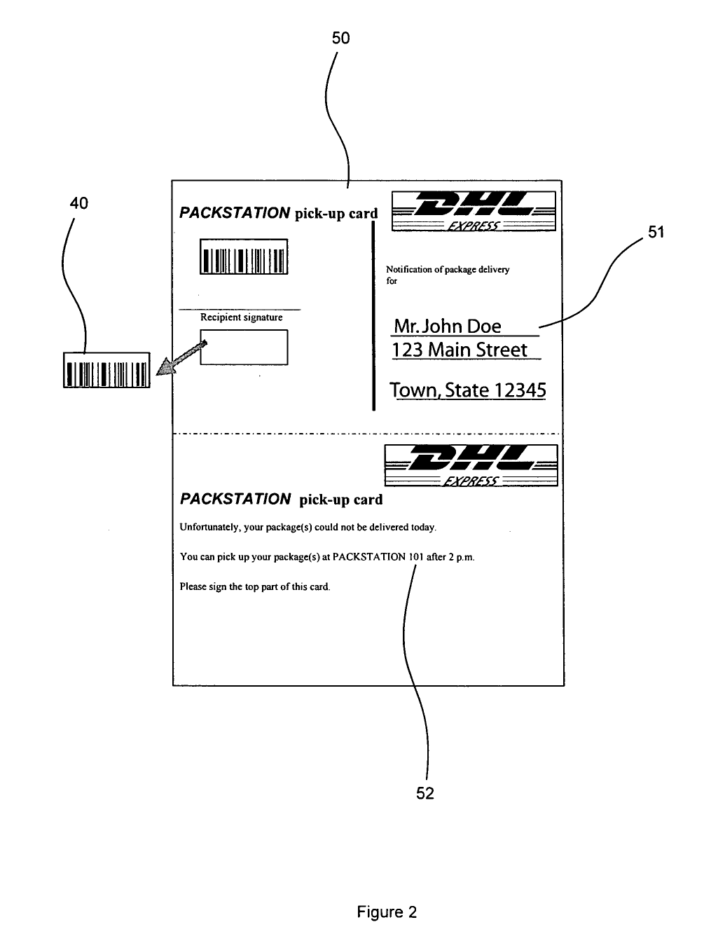

FIG. 2 an especially preferred embodiment of a notification means.

FIG. 1 shows a schematic depiction of the sequences of the method according to the invention. When a deliverer determines at a delivery address 20 that he cannot hand over a shipment to an authorized recipient 30, he deposits a notification means 50 at the delivery address and transports the shipment to a parcel compartment system 60. The notification means 50 is preferably a notification card of the type shown by way of example in FIG. 2. The notification means 50 is provided at least with information 52 for identifying a parcel compartment system with free compartments, with data 51 of the recipient and with identification means 40.

In the arrangement according to the invention, the identification means is generated by a means 80 while a second means 90 provides information about free compartments of a parcel compartment system. The means 90 for generating information about free compartments can preferably be connected to a central data management unit 70, whereby the data management unit can be connected to at least one parcel compartment system of the entire arrangement. Preferably, data about all delivery and pick-up procedures at a parcel compartment system is transmitted to the data management unit where it is stored. In this manner, the data management unit has access to currently available free compartments and can transmit this information, for example, to a means 90.

In an especially preferred embodiment of the invention, when a recipient is associated with a storage place in a parcel compartment system, a specific compartment is also reserved to receive the shipment of the recipient. This can be done, for example, by means of a mobile device that the recipient carries so that he can transmit the reservation of a compartment to a pertinent means. The latter can be, for example, the applicable parcel compartment system directly or else the central data management unit that then forwards the information to the parcel compartment system.

In another especially preferred embodiment of the invention, when a recipient is associated with a storage place in a parcel compartment system, no reservation for a specific compartment is made yet but rather the definitive assignment is only made once the deliverer would like to place a shipment into a parcel compartment system.

The association of a free compartment with a recipient is made by the deliverer via an identification means. The association is an integral part of the generation of the notification means. Here, the notification means can be generated in various ways.

In an especially preferred embodiment of the invention, before the deliverer begins his delivery route, a notification means is generated for each available compartment in the district of the delivery route. This is done, for example, in that a notification card is printed in a delivery base station via an application. In this case, the means 80 for generating an identification means 40 and the means for generating information about free compartments are both in the area of the delivery base station.

Advantageously, the identification means is a barcode. It has proven to be especially advantageous for the identification means to be present in duplicate on the notification card. For example, the code can be printed directly onto the card as well as onto a peel-off sticker. As a result, the deliverer can pull off the sticker and apply it onto the shipment for which he is providing a notification. This has the advantage of associating not only the recipient but also the shipment with the issued code.

Such a notification card can also contain location information about a parcel compartment system and/or about the size of a compartment. The deliverer can then take a card along with him on his route for each available compartment in his delivery district. Hence, the deliverer has information about the number and size of free compartments already before he begins the delivery route, which facilitates the capacity utilization planning. As a result, the deliverer knows the current compartment availability and does not assign compartments twice.

When a deliverer reaches the delivery address of a recipient but does not encounter the recipient or an authorized substitute recipient there, he leaves one of the notification cards he is carrying along at this delivery address. For this purpose, he selects a notification card indicating the nearest parcel compartment system that has an available compartment of a suitable size. The deliverer fills in certain personal data about the recipient on the card and peels off the adhered identification means from the notification card. The peeled-off identification means is preferably placed onto the shipment that is to be delivered. In an especially preferred embodiment of the invention, the deliverer notes additional information on the notification card such as, for example, a COD charge that has to be paid at the time of pick-up and/or the earliest possible time when the shipment can be picked up.

If there is no duplicate identification means that can be peeled off, then other modalities of recording and transmitting the issued identification can be used. The deliverer can, for example, write down the identification means of the notification card and/or apply it manually onto the shipment. Then, for instance, he writes a numerical code or a letter code onto the shipment.

In another especially preferred embodiment of the invention, the notification cards are not generated ahead of time before the start of a delivery route, but rather, the deliverer can generate a notification means at a delivery address as the need arises. For this purpose, he can have a portable device such as a handheld device that is connected to the central data management unit 70. This connection can be, for example, a radio connection or a GSM connection. The means 90 for generating information about free compartments would thus be in the portable device and would display free compartments and/or would apply this information onto a notification means. In this manner, the deliverer is always aware of the current capacities of parcel compartment systems. The means 80 for generating identification means can also be located in the portable device so that, for example, a required code is generated on site. In another embodiment of the invention, the deliverer carries along prepared notification cards that are already provided with a code and that merely have to be supplemented with recipient data and parcel compartment system data.

This method has the advantage that the deliverer does not have to carry along notification cards for all of the free compartments in the parcel compartment systems since, if these cards were not used during the delivery route, they cannot be used again in view of the fact that the capacities for the next delivery run would already have changed. Moreover, it is advantageous that—via the central data management unit—the deliverer always has access to the current capacity utilization of the parcel compartment systems, whereby he can also request information about parcel compartment systems outside of his delivery district.

The depositing of shipments about which a recipient has been notified as described above can comprise a number of variants, depending on the type of procedure. The simplest variant, for instance, involves a shipment that does not require proof of delivery. The deliverer signs in at the parcel compartment system, which can be done in a known manner, for example, by means of an identification card and/or a PIN code. Then he uses the electronic controls of the parcel compartment system to select the option of depositing a shipment for which a notification has been issued. If a barcode is used as the identification means, the deliverer scans it in from the shipment in question. The deliverer selects a required compartment size and places the shipment into a compartment. The compartment is closed and the delivery is completed. The recorded data is transmitted to the central data management unit 70 which can be, for instance, a server.

If the item to be deposited is a COD shipment for which the recipient has to pay a monetary sum upon receipt, then another embodiment of the invention is advantageously used since, in addition, a COD sum has to be recorded. The identification and the recording of the identification means, for example, can be retained, whereby the deliverer can previously have selected a special option, namely, “COD delivery”. Consequently, the deliverer can enter the COD sum and preferably also the name of the sender. The further steps of the delivery process can be the same as those for shipments that do not require proof of delivery. In addition, the deliverer can record a shipment-specific identification code that is, for example, likewise located on the shipment in the form of a sticker.

The pick-up of a shipment for which a notification has been issued from a parcel compartment system constitutes the simplified form of pick-up of a shipment at a branch office of a delivery company and is likewise carried out depending on the type of procedure. Here, the person picking up the shipment has to be identified and this procedure should preferably meet the requirements that apply to picking up shipments at the branch office. This is aimed at preventing a person from gaining possession of a notification card and from receiving a shipment from a parcel compartment system without authorization. At the least, a person picking up a shipment should be identifiable to such a degree that this person can be determined in case of an unauthorized pick-up. Therefore, the identification of the person picking up a shipment that does not require proof of delivery should have to meet different requirements from the identification in case of a shipment that requires proof of delivery. Thus, advantageously, the appertaining processes at a parcel compartment system are different.

Here, too, the simplest variant is the picking up of a shipment that does not require proof of delivery by a notified recipient or by an authorized substitute. The recipient or an authorized substitute go to a parcel compartment system and take along a notification card. Since a parcel compartment system can also be used for other types of procedures, it has proven to be advantageous to provide a special menu item for the method according to the invention in the electronic controls of the parcel compartment system. The person picking up the shipment thus selects the appropriate menu item and is then, for example, prompted to record the identification means of the notification card. Depending on the identification means, the recipient can scan in the barcode or can enter the code via an input means. The parcel compartment system then associates a deposited shipment with the identification means and releases the shipment.

In order to pick up shipments that do not require proof of delivery at a branch office of a postal service provider, for example, the signature of the person picking up the shipment is sufficient to confirm the pick-up. In order to duplicate this in a parcel compartment system, in an especially preferred embodiment of the invention, the person picking up the shipment is prompted to likewise provide his signature. This can be done, for instance, with a touch screen. In another especially preferred embodiment of the invention, the person picking up the shipment signs the notification card and places it into the parcel compartment system. This can be done, for instance, by placing it into a compartment. The placement into a compartment has the advantage that the identification means as well as the barcode can be read in directly from the notification card, whereby at the same time, additional information such as the signature can be photographed.

Since hand-written texts on the notification card can be erroneous or illegible, it can also be advantageous to record the identity of the person picking up the shipment in an unambiguously readable form in that he enters his personal data via a keyboard. Here, it has to be taken into account that the particulars could be incorrect, so that it is not possible to determine with certainty whether the person picking up the shipment is authorized to do so or not. However, in the case of shipments that do not require proof of delivery, it is not necessary to prove that the shipment was released to the recipient. If proof is nevertheless advantageous, then it can be undertaken at this point.

After the confirmation by the signature or other identity information, the shipment is released for removal. The recipient removes the shipment and closes the compartment. The parcel compartment system then advantageously sends a message about the event to the central data management unit.

If a COD shipment that requires proof of delivery was placed into a parcel compartment system, a different process has proven to be advantageous for the pick-up. If a recipient wishes to use a parcel compartment system to pick up a COD shipment for which he has received a notification card, he goes to the appropriate parcel compartment system, taking along the notification card and an electronic purse that is accepted by the parcel compartment system. In another embodiment of the invention, the possibility exists for the person picking up the shipment to pay a monetary sum by making a cash payment.

After the selection of a menu item for COD shipments, the identification means of the shipment to be picked up can be recorded, as was already described. The parcel compartment system allocates the shipment and, in an especially preferred embodiment, displays the amount to be paid as well as the sender. Then the customer is prompted to pay for the shipment with an electronic purse. This can involve, for example, the entry of a PIN code. After the payment has been made, the recipient is preferably prompted to sign on a touch screen. After the signature has been confirmed, the shipment is released for removal. In an especially preferred embodiment of the invention, a receipt indicating payment of the shipment is printed. The recipient removes the receipt and the shipment and then closes the compartment. The parcel compartment system sends a message about the removal to the central data management unit.

For example, EC cards and/or credit cards can be used as electronic purses. If the possibility exists to determine the identity of the person picking up the shipment on the basis of the electronic purse, this is especially advantageous since in this manner, one means fulfills two functions. If the identity of the person picking up the shipment cannot be determined on the basis of the electronic purse, then other methods can be employed.

For example,.the person picking up the shipment at the parcel compartment system can be identified via the notification card and his personal identity card. For this purpose, the package recipient has received and signed the notification card with the notification code and the parcel station printed on it. He has gone to the indicated parcel compartment system and has taken along the notification card and his personal identity card. Via a menu item, the user indicates that he would like to pick up a shipment for which he has received a notification. Then a scanner compartment in the parcel compartment system opens. The package recipient is prompted to insert the signed notification card. The compartment closes and the notification code is read from the card. Moreover, the signature is photographed and then the card is ejected.

After the notification code has successfully been checked, the package recipient is prompted to identity himself with his personal identity card and to place it into the scanner compartment. Various data items, for example, can be read from the personal identity card. These preferably include first and last name, address, personal identity card number and additionally the signature. Once the data has been read, the personal identity card is ejected again and can be removed by the recipient.

Once the comparison of the name and address on the package with the personal identity card has been successfully completed, the appropriate compartment is opened and the customer can remove his package. If the comparison was not successful, it is advantageously possible for the menu to query whether the person picking up the shipment is authorized for the pick-up. If so, then the package could also be released since the personal identity card particulars of the person picking up the shipment have been recorded in case of an unauthorized pick-up. Since no positive comparison can be made between the indicated data and the correct data read in from the personal identity card if the names or addresses of the recipient have been entered incorrectly, a substitute function can be provided in this case so that the recipient can receive the shipment in any case. This can be done, for example, by means of the same function that handles the pick-up by a substitute recipient. All of the recorded data is stored so that, in case of a problem or in case of a search, the identity of the person picking up the shipment can be traced.

In another preferred embodiment of the invention, the comparison establishes a degree of correspondence between the data about the indicated recipient and the data about the person picking up the shipment. The degree of correspondence could be, for example, 70% so that minor deviations due to different ways of writing or due to spelling mistakes do not lead to the refusal to release a shipment. In another embodiment, for example, only the last name of a person picking up the shipment is evaluated. If none of the processes yield a sufficient match, the release of the package is refused.

Identification by means of a personal identity card has the advantage that it is very easy for the user to perform since he merely has to insert his personal identity card. At the same time, a high level of security is ensured for the operator of the parcel compartment system since not only the name and address of the person picking up the shipment and of the recipient are known, but in case of a problem, the person picking up the shipment can be unambiguously identified via his personal identity card.

In another especially preferred embodiment of the invention, the person picking up the shipment is identified via the presentation of any identification card that contains his name. This can be, for example, a health insurance card or a driver's license. If the identity of the user is stored on the card, this can be read out by the parcel compartment system. If this is not the case or if a reading out of the identity is not permitted, then the user can be prompted, for example, to place the signed card into a compartment of the parcel compartment system. The compartment is closed and the card is scanned on both sides. The person picking up the shipment can additionally be prompted to sign on a signature pad. Then he can remove his card as well as the package.

In another especially preferred embodiment of the invention, The sender provides information that accompanies the shipment, thus giving the recipient and the delivering postal service provider an in-house customer number or a TAN that the recipient has to enter at the parcel compartment system in addition to the notification code in order to remove the shipment. This method ensures the confirmation that the recipient and the person picking up the shipment are one and the same person. In addition, if necessary, the signature of the person picking up the shipment can also be required.

Another means for ensuring the identity of the person picking up the shipment is to generate a photograph of this person. In another embodiment, the identification is made via a call to a cell phone including phone number transmission to a specific number of the parcel compartment system. The owner of the phone can be verified via the card contract of the cell phone.

### LIST OF REFERENCE NUMBERS

10 shipment
20 delivery address
30 recipient
40 identification means, barcode
50 notification means, notification card
51 recipient data
52 data for identifying a parcel compartment system
60 parcel compartment system
70 central data management unit, server
80 means for generating an identification means
90 generation of information about free compartments in a parcel compartment system

1. A method for delivering a shipment to one of several electronic parcel compartment systems, wherein the shipment is transported to a delivery address at which a notification is deposited if it is determined that the shipment cannot be handed over to an authorized recipient,
the method comprising the following steps:
of connecting a central data management unit to at least one electronic parcel compartment system in order to transmit information about free compartments in the parcel compartment system to the data management unit and transmitting the information about free compartments to a mobile device in order to generate information about free compartments in a parcel compartment system;
evaluating the information of the mobile device about free compartments in a parcel compartment system and associating a storage place in a parcel compartment system with a recipient of the shipment via an identifier, whereby the notification is provided at least with data for identifying the parcel compartment system, with data about the recipient and with the identifier;
depositing of the shipment in a compartment of an electronic parcel compartment system, whereby at least the identifier associated with the recipient of the shipment is recorded and stored so as to match the compartment in question;
a person picking up the shipment at the parcel compartment system,
recording at least the identifier associated with the recipient of the shipment,
comparing the identifier associated with the recipient of the shipment and the identifier stored for occupied compartments, and
releasing the deposited shipment from a compartment if the result of the comparison shows that the identifier associated with the recipient matches an identifier stored for the compartment in question.

2. The method according to claim 1, comprising
associating an identifier with a storage place in a parcel compartment system before determining that the shipment cannot be handed over to an authorized recipient at the delivery address.

3. The method according to claim 1, comprising
associating an identifier with a storage place in a parcel compartment system after determining that the shipment cannot be handed over to an authorized recipient at the delivery address.

4. The method according to claim 1, comprising,
when a recipient is associated with a storage place in a parcel compartment system by an identifier, reserving a compartment is in a parcel compartment system, wherein the reservation is made via a mobile device.

5. The method according to claim 1, comprising,
when the shipment is deposited in the parcel compartment system and/or when the shipment is picked up from the parcel compartment system, transmitting data about each procedure to a central data management unit.

6. The method according to claim 1, comprising,
when the shipment is deposited in a parcel compartment system, recording a monetary sum, wherein the payment of this monetary sum is a prerequisite for the release of the shipment when someone picks up the shipment.

7. The method according to claim 1, comprising,
when the shipment is deposited, recording data about the recipient and when someone picks up the shipment, recording data about the person picking up the shipment, wherein the correspondence of said data is a prerequisite for the release of the shipment when a person picks up the shipment, whereby if the data about the recipient and the data about the person picking up the shipment do not match, activating a function by means of which the person picking up the shipment can indicate that he is a substitute recipient, which is a prerequisite for the release of the shipment.

8. The method according to claim 1, comprising
recording the signature of the person picking up the shipment when said person picks up the shipment.

9. The method according to claim 8, comprising
the signature by the notification that has been provided with the signature.

10. The method according to claim 8, comprising
recording the signature by a personal identity card that has been provided with the signature.

11. An arrangement for carrying out a method for delivering a shipment to one of several electronic parcel compartment systems according to claim 1, wherein the arrangement comprises at least one central data management unit and several electronic parcel compartment systems each of said electronic parcel compartments systems having a device for exchanging data, and wherein the parcel compartment system has at least device for recording, storing and comparing identifier, wherein
the arrangement comprises at least the following components:
a device for generating an identifier, whereby the identifier serves to associate a recipient of a shipment with a storage place in a parcel compartment system;
a mobile device for generating information about free compartments in a parcel compartment system, whereby the mobile device can be connected to the central data management unit and the information serves to associate a recipient of a shipment with a storage place; and
a device generating a notification, whereby the notification can be provided with data for identifying a parcel compartment system, with data about the recipient and with the identifier.

12. The arrangement according to claim 11, wherein
the identifier comprising at least one of a barcode, a numerical code and a letter code.

13. The arrangement according to claim 11, wherein
the notification is provided with two identical identifiers, wherein at least one identifier can be detached from the notification.
